(19) United States
(12) Patent Application Publication
(10) Pub. No.: US 2005/0230957 A1
(43) Pub. Date: Oct. 20, 2005

(54) Photo album sheet

(76) Inventor: Thomas A. Holmberg, Minneapolis, MN (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/826,666

(22) Filed: Apr. 16, 2004

(51) Int. Cl. B42D 1/00

(52) U.S. Cl. 283/38

(57) ABSTRACT

An album sheet includes a binding edge and an opposite, outside edge. A film is attached to the sheet and extends along at least a portion of the opposite, outside edge. The film can be wrapped around the outside edge so that a portion of the film is on each side of the sheet. The sheet can include a mounting strip and a flexible film strip connecting the mounting strip to the binding edge of the sheet such that there is a gap between the mounting strip and the sheet. The flexible film strip can be wrapped around an outer, spine edge of the mounting strip. A plastic overlay can be attached to one edge of the sheet and dimensioned to cover at least a portion of the sheet.

### FIELD

This invention relates to the field of sheets, and more specifically to sheets for photo albums.

### BACKGROUND

For many years photo albums have existed in various forms. One particular type is called a post-bound album. Typically these albums have pages made of paper with two holes punched into the end of sheets where the posts are inserted. The photos are attached to these sheets with corners or tapes. Sometimes three or four photos are attached to each page on each side. These photos add a great deal of weight to the paper page. Depending on the final size of the album there may be twenty to fifty, or more, pages in the album. The posts mentioned before are used to hold the pages into the album. This is done by fitting the sheets over the posts, fitting the cover over the posts and screwing the post cap onto the post. When assembled the sheets will now be held into the album by the two posts. This method of binding can cause problems in different ways. First, if the album is stored on end in a vertical position the weight of the photographs is causing a constant pulling action against the posts. Because the paper used to hold the photos is inherently weak, there is a danger that the paper will eventually tear away from the posts. The second issue is similar to the first but the person who is looking at the album causes the tearing action. Each time they turn a page they are pulling on the posts with the paper. Eventually this will tear away.

A second problem seen on these pages occurs on the opposite end of the sheet. In normal use each paper is routinely handled on the edge. Over time this edge becomes worn, dirty and may even rip. Again because of the weak nature of the paper this wear is inevitable.

Another problem is caused by the general construction of many post binders. Because of this construction the spine edge of the album sheets is left exposed. These exposed edges can become dirty or damaged as the album is handled or stored. Over an extended period of time this leads to an unattractive album and may lead to premature paper failure.

All these problems become even more pronounced when viewed in the light that the intent of these albums is to create a permanent archive for the enclosed photos. After being viewed only a few times these problems of wear and cleanliness become evident.

### SUMMARY

One aspect of the present invention includes a sheet having a binding edge and an opposite, outside edge. A film is attached to the sheet and extends along at least a portion of the opposite, outside edge. In some options the film can be wrapped around the outside edge so that a portion of the film is on each side of the sheet. The film can protect the sheet from fingerprints and seals the edge of the sheet from air and dirt, for example.

One aspect includes a sheet having a binding edge and an opposite, outside edge, a mounting strip, and a flexible film strip connecting the mounting strip to the binding edge of the sheet such that there is a gap between the mounting strip and the sheet. The flexible film strip is wrapped around an outer, spine edge of the mounting strip. Again, this wrapped film can protect the edge of the sheet. In some options a plastic overlay is attached to one edge of the sheet and covers at least a portion of the sheet.

### BRIEF DESCRIPTION OF THE DRAWINGS

FIG. 1 shows a top view of an album sheet according to one embodiment.

FIG. 2 shows a bottom view of the album sheet of FIG. 1.

FIG. 3A shows a bottom view of a mounting strip according to one embodiment.

FIG. 3B shows a bottom view of the mounting strip of FIG. 3A, partially folded.

FIG. 4 shows a perspective view of an album sheet according to one embodiment.

FIG. 5 shows a bottom view of the album sheet of FIG. 4.

### DETAILED DESCRIPTION

The following detailed description and accompanying drawings show various embodiments according to the inventive subject matter disclosed herein. These embodiments are described in sufficient detail to enable those skilled in the art to practice the invention. Other embodiments may be utilized and structural changes may be made without departing from the scope of the present invention.

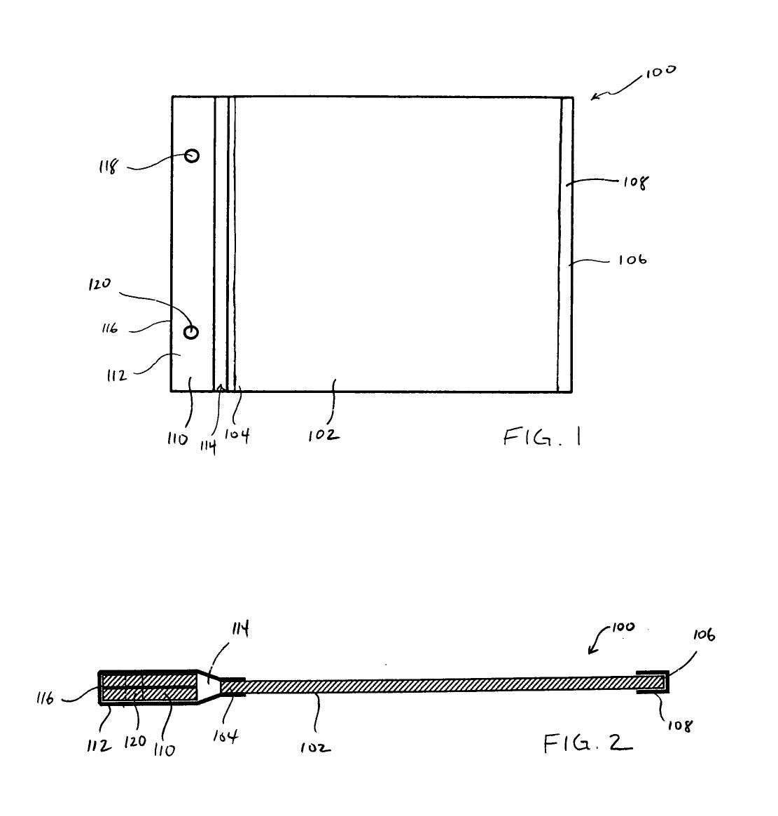

FIGS. 1 and 2 shows a top view and bottom view, respectively, of an album sheet 100 according to one embodiment. Sheet 100 is designed to help create a photo archive page that can stand up to extended and repeated use. Sheet 100 generally includes a sheet page 102 having a binding edge 104 and an opposite, outside edge 106. Sheet page 102 can be a 12″×12″ sheet of 80 # cover stock, for example. Optionally, page 102 can be other paper stock or a white polyester or other plastic.

In one embodiment, a film 108 is attached to sheet page 102 and extends along at least a portion of outside edge 106. In some embodiments, film 108 can wrapped around outside edge 106 so that a portion of film 108 is attached to each side of sheet page 102. Thus, film 108 covers the top surface of the sheet, the edge surface of the sheet, and the bottom surface of the sheet. Film 108 can be wrapped around the edge 106 of the page sheet 102 so that the film extends about ⅜″ from the edge surface on each side of the sheet.

Film 108 protects the sheet from fingerprints and seals the edge of the sheet from air, dirt, oil absorption, and splitting of the edge of the sheet, for example. This helps solve the issue of the wear that occurs on the outside edge. With the addition of this film the dirt and wear of handling is eliminated. In some embodiments, film 108 can include a polypropylene film, a polyester film, or other thin tape film. The film 108 can have a thickness of about 0.001″ thick. Film 108 can be attached to the sheet page 102 by an acrylic laminating adhesive, a heat-activated adhesive, or a pressure-sensitive adhesive, for example. For example, the film could be adhered to the paper with an acrylic laminating adhesive such as a water based aliphatic urethane as made by HB Fuller of St. Paul Minn. or a heat activated adhesive such as an ethylene co-polymer as made by Protectall of Darin Wis.

In one embodiment, sheet 100 includes a mounting strip 110 and a flexible film strip 112 connecting mounting strip 110 to binding edge 104 of sheet page 102 such that there is a gap 114 between mounting strip 110 and sheet page 102, thus forming a hinged structure. In one embodiment a pair of film strips can attach mounting strip 110 to page 102, with one strip on each side of the sheet. One embodiment attaches strip 112 using a water based acrylic emulsion adhesive for a permanent bond that can stand up to archive use. In some embodiments, mounting strip 110 can have a width of about ⅞″ and gap 114 can be about 3/16″.

In one embodiment, a single film strip 112 is wrapped around an outer, spine edge 116 of mounting strip 110. Strip 112 can be a polypropylene or a polyester film, for example. Again, such a wrapped configuration protects the mounting strip and seals the edge of the strip from air, dirt, oil absorption, and splitting of the edge of the strip, for example.

In one embodiment, mounting strip 110 includes two or more post holes 118 and 120. Film strip 112 also includes holes located over post holes 118 and 120 and thus the film strip 112 material completely surrounds and reinforces the post holes. This reinforcement provides extra strength to prevent sheet 100 from being torn out or falling out of an album. It reinforces the post holes on both the top and bottom. By reinforcing the holes with film, the strength of the holes is greatly increased, especially since it is on both the top and bottom of the sheet.

In one embodiment, mounting strip 110 can have a thickness greater than the thickness of the sheet page 102. For example, mounting strip can be at least twice as thick as the sheet page 102. In some embodiments, mounting strip 110 can include a single a folded sheet, with the folded configuration doubling the thickness of the sheet. This extra thickness at the binding edge of sheet 100 helps compensate for the thickness of photos that a user will attach to sheet page 102. This helps keep a filled photo album flatter and neater. Without the extra thickness, a filled album tends to form a wedge shape, placing extra stress on the binding.

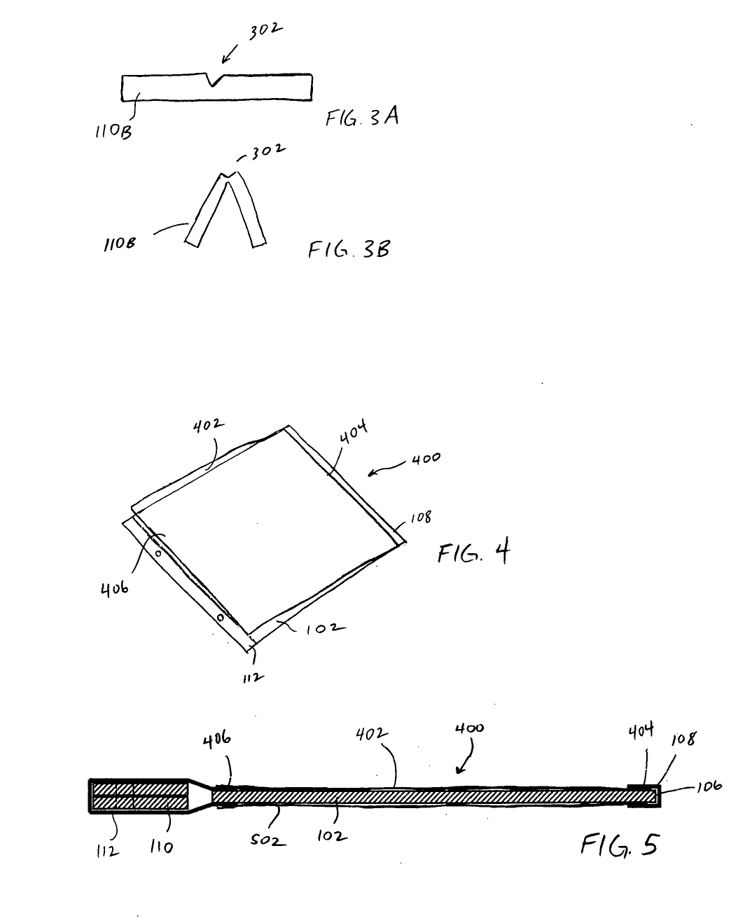

FIGS. 3A and 3B shows a bottom view of a mounting strip 110B, in accordance with one embodiment. In some examples, mounting strip 110B is used with sheet 100 described above. Mounting strip 110B is a sheet that is folded to form a double-thick mounting strip. Mounting strip 110B includes a notch 302 formed directly over the fold of the strip. As can be seen in FIG. 3B, when the strip is folded into its final configuration, notch 302 provides relief so that the paper in the fold does not bunch up within the fold. The addition of the notch weakens the paper slightly. However, the addition of strip 112 (FIG. 2), wrapped around the spine edge of mounting strip 110B, protects the weakened edge.

FIGS. 4 and 5 shows a perspective view and a bottom view of an album sheet 400, according to one embodiment. Album sheet 400 can include any of the features of sheet 100 discussed above and certain details will be omitted for the sake of clarity. Sheet 400 generally includes sheet page 102, mounting strip 110, and film strips 108, and 112. Sheet 400 also includes a plastic overlay 402 which is dimensioned to cover at least a portion of sheet page 102. Overlay 402 is added to the page to cover and protect the photos. Some examples cover the entire page 102 by using an overlay sheet roughly the same size as the page. In one embodiment, overlay 402 has a first edge 404 attached proximate the outside edge 106 of page 102 by film 108. The opposite edge 406 of the overlay is loose and used to lift the overlay to mount photos onto the page. Some embodiments omit strip 108 and the overlay is attached by adhesive along the edge of the sheet page.

In other embodiments, edge 406 of overlay 402 can be attached along the binding edge of sheet 400 by strip 112 while leaving edge 404 loose.

In some embodiments, overlay 402 can be a clear plastic overlay, such as a polypropylene sheet having a thickness of approximately 0.001″ to approximately 0.003″. A static charge can be applied to the overlay film to help hold it in place against the paper page. Optionally, one could also apply a light-tack adhesive to the page, perhaps near the binding edge, to help hold the film in place.

Some embodiments include a second overlay 502 applied to the opposite side of sheet page 102.

One method to produce sheets in accordance with an embodiment of the present invention begins with a web fed printing press such as a Didde VIP made by Alco Standard Corp. A web of paper is fed through this machine passing several processing stations. (It is assumed that normal web handling equipment and techniques will be used throughout this process and such equipment will not be described)

A first processing station is used to score and slit the mounting strip of the album sheet, such as 80# cover stock—Archival quality made by Fox River Paper of Appleton Wis., this narrow edge is then folded in half along the score line and is fed along side of the other web.

Through a series of rollers and guides the separate, folded, web of mounting strip paper is aligned along side the primary sheet page web maintaining a gap of about ¼″. Other gap distances are acceptable also.

A roll of polypropylene or polyester, such as made by Transilwrap of Franklin Park Ill., is unwound, coated on one side with adhesive and guided to laminate both the folded mounting strip web and the main sheet page web maintaining the ¼″ dimension. This film can be laminated with half its width off the web of material. This half of the web is now folded around and under the web and laminated in place. Through a series of rollers and nips this film web is firmly laminated to the paper on both the top and bottom.

A second narrower web of polypropylene or polyester film is unwound and similarly attached to the opposite, non binding edge, of the main sheet page web. This narrower portion is folded under along the previously made score line, and laminated to the underside the main web.

The completed web is punched by conventional methods and is cut to length in a conventional sheeter at the end of the press.

If a plastic overlay is applied to the sheet, the overlay can be applied at the same time as the process above, and a static charge can be applied to the overlay, for example.

The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A sheet for an album, the sheet comprising:
a sheet having a binding edge and an opposite, outside edge; and
a film attached to the sheet and extending along at least a portion of the opposite, outside edge.

2. The sheet of claim 1, wherein the film extends at least about ⅜″ from the outside edge.

3. The sheet of claim 1, wherein the film includes a polypropylene film.

4. The sheet of claim 1, wherein the film is wrapped around the outside edge so that a portion of the film is attached to each side of the sheet.

5. The sheet of claim 1, wherein the film includes a polyester film.

6. The sheet of claim 1, wherein the film is adhered to the sheet with an acrylic laminating adhesive.

7. The sheet of claim 1, wherein the film is adhered to the sheet with a heat-activated adhesive.

8. The sheet of claim 1, wherein the film is adhered to the sheet with a pressure-sensitive adhesive.

9. The sheet of claim 1, including a second film attached adjacent the binding edge of the sheet.

10. The sheet of claim 1, further including a plastic overlay at least partially covering the sheet.

11. The sheet of claim 10, wherein the plastic overlay is attached proximate the outside edge of the sheet by the film.

12. A sheet for an album, the sheet comprising:
a sheet having a binding edge and an opposite, outside edge;
a mounting strip; and
a flexible film strip connecting the mounting strip to the binding edge of the sheet such that there is a gap between the mounting strip and the sheet, wherein the flexible film strip is wrapped around an outer, spine edge of the mounting strip.

13. The sheet of claim 12, wherein the mounting strip has a thickness greater than the thickness of the sheet.

14. The sheet of claim 13, wherein the mounting strip is at least twice as thick as the sheet.

15. The sheet of claim 13, wherein the mounting strip includes a folded sheet.

16. The sheet of claim 15, wherein the folded sheet includes a notch located at a fold of the folded sheet.

17. The sheet of claim 12, wherein the mounting strip includes two or more post holes and the flexible film strip is adapted to reinforce the post holes.

18. The sheet of claim 12, further including a second film attached to the sheet and extending along at least a portion of the opposite, outside edge.

19. The sheet of claim 18, wherein the film is wrapped around the outside edge so that a portion of the film is attached to each side of the sheet.

20. The sheet of claim 12, further including a plastic overlay at least partially covering the sheet.

21. The sheet of claim 20, wherein the plastic overlay is attached proximate the binding edge of the sheet by the film strip.

22. The sheet of claim 20, wherein the plastic overlay is attached proximate the outside edge of the sheet by a second film attached at the outside edge of the sheet.

23. A sheet for an album, the sheet comprising:
a sheet having a binding edge and an opposite, outside edge;
a mounting strip; and
a flexible film strip connecting the mounting strip to the binding edge of the sheet such that there is a gap between the mounting strip and the sheet;
wherein the mounting strip has a thickness greater than the thickness of the sheet.

24. The sheet of claim 23, wherein the mounting strip is at least twice as thick as the sheet.

25. The sheet of claim 23, wherein the mounting strip includes a folded sheet.

26. The sheet of claim 25, wherein the folded sheet includes a notch at a fold of the folded sheet.

27. The sheet of claim 23, wherein the mounting strip includes two or more post holes and the flexible film strip is adapted to reinforce the post holes.

28. The sheet of claim 23, further including a second film attached to the sheet and extending along at least a portion of the opposite, outside edge.

29. A sheet for an album, the sheet comprising:
a sheet having a binding edge and an opposite, outside edge;
a mounting strip;
a flexible film strip connecting the mounting strip to the binding edge of the sheet such that there is a gap between the mounting strip and the sheet; and
a plastic overlay attached to the sheet and covering at least a portion of the sheet.

30. The sheet of claim 29, wherein the plastic overlay is attached proximate the binding edge of the sheet by the film strip.

31. The sheet of claim 29, wherein the plastic overlay is attached proximate the outside edge of the sheet by a second film attached at the outside edge of the sheet.

32. The sheet of claim 29, wherein the plastic overlay is a clear plastic overlay.

33. The sheet of claim 29, wherein the plastic overlay includes a approximately 0.001″ to approximately 0.003″ polypropylene sheet.

34. The sheet of claim 29, wherein a static charge is applied to the plastic overlay.

35. The sheet of claim 29, further including a second plastic overlay applied to an opposite side of the sheet.

36. The sheet of claim 29, further including an adhesive applied to the sheet to hold the overlay against the sheet.
